(19) United States
(12) Patent Application Publication
(10) Pub. No.: US 2026/0328318 A1
(43) Pub. Date: Oct. 22, 2026

(54) THREAD FORM WITH CONSTRICTOR NOTCH

(71) Applicant: FERMATA TECHNOLOGIES, LLC, Houston, TX (US)

(72) Inventors: Ryan Michel BROUSSARD, Houston, TX (US); Wesley Lyman OTT, Houston, TX (US)

(73) Assignee: FERMATA TECHNOLOGIES, LLC, Houston, TX (US)

(21) Appl. No.: 19/183,167

(22) Filed: Apr. 18, 2025

(51) Int. Cl. E21B 17/042; F16L 15/00; F16L 15/06

(52) U.S. Cl. CPC E21B 17/042; F16L 15/06; F16L 15/001

(57) ABSTRACT

A tubular is disclosed that provides a tooth that includes a first transition surface extending from a load side root, a load flank extending from the first transition surface, a second transition surface extending from the load flank, a third transition surface extending from the second transition surface, a stab flank extending from the third transition surface, and a fourth transition surface extending from the stab flank and transitioning to a stab side root. The third transition surface comprises a first linear portion extending from the second transition surface, a first arcuate portion extending radially from the first linear portion, a second linear portion extending linearly from the first arcuate portion, a second arcuate portion extending radially from the second linear portion, a third linear portion extending linearly from the second arcuate portion, and a third arcuate portion extending radially from the third linear portion to the stab flank.

### BACKGROUND

In the oil and gas industry, several types of tubing and pipe are used in exploration, completion, and production operations designed to locate and extract hydrocarbons from subterranean hydrocarbon-bearing formations. Common types of oilfield tubing include drill pipe, casing (or liner), and production tubing. Relatively short pipe sections of 30 to 40 ft. in length are conventionally coupled end-to-end to make long strings of interconnected pipes. Connected sections of drill pipe, for example, form a drill string used to deepen or work over the well. Connected sections of casing or liner pipe are used to encase the walls of a drilled wellbore and provide structural support for the well. And connected sections of production tubing are used to convey (transport) the subsurface hydrocarbon reserves (e.g., oil or gas) to the well surface.

Each of the different types of pipe has a threaded end configuration specially designed to meet its intended purpose as it structurally secures and seals the pipe ends together. Common threaded connections include a male threaded member or “pin end” at the end of a tubular section, which engages a female threaded member or “box end” at the end of an adjoining tubular section. In some instances, a thread compound may be applied to the pin and box threads as they are joined together. This thread compound, sometimes referred to as “pipe dope” or “thread dope,” provides lubrication as pipes or connections are assembled and helps fill voids between threads.

As industry demands connectors with increasingly high tensile strength, pressure strength, and torque, etc., the general features of connectors may be designed and engineered to meet downhole performance criteria. Connectors may be further designed to incorporate intentional voids for containing thread compound while meeting high performance criteria. However, these voids may sacrifice pressure performance in the threaded connection as they tend to just relieve the thread compound.

Accordingly, there is a need for an improve threaded connection that includes a void for holding and pressurizing the thread compound, not just relieving the thread compound.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic diagram of an example drilling system that may incorporate the principles of the present disclosure.

FIG. 2 is a cross-sectional side view of a threaded connection, in accordance with at least one aspect of the present disclosure.

FIG. 3 is an enlarged view of the threaded engagement between the external and internal thread profiles of FIG. 2, in accordance with at least one aspect of the present disclosure.

### DETAILED DESCRIPTION

The present disclosure is related to threaded tubulars and, more particularly, to designs and configurations for pin ends of threaded downhole tubulars and pipes.

Embodiments disclosed herein describe threaded pipe connections that include a first tubular member having a pin end defining an external thread profile. The external thread profile provides a tooth that includes a first transition surface extending from a load side root, a load flank extending from the first transition surface, a second transition surface extending from the load flank, a crest extending from the second transition surface and including a third transition surface, a stab flank extending from the third transition surface, and a fourth transition surface extending from the stab flank and transitioning to a stab side root. The third transition surface of the external threads comprises a first linear portion extending from the second transition surface, a first arcuate portion extending from the first linear portion, a second linear portion extending from the first arcuate portion, a second arcuate portion extending from the second linear portion, a third linear portion extending from the second arcuate portion, and a third arcuate portion extending from the third linear portion to the stab flank.

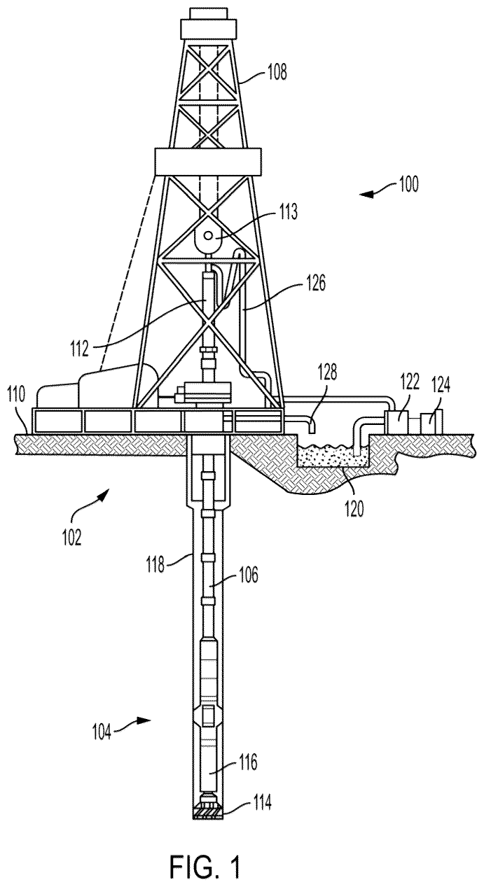

FIG. 1 is a schematic diagram of an example drilling system 100 that may incorporate the principles of the present disclosure. Boreholes may be created by drilling into the earth 102 using the drilling system 100. In the illustrated example, the drilling system 100 includes a bottom hole assembly (BHA) 104 positioned or otherwise arranged near the bottom of a drill string 106 extended into the earth 102 from a derrick 108 arranged at the surface 110.

The BHA 104 includes a drill bit 114 operatively coupled to the end of a tool string 116 that extends axially within a drilled wellbore 118. During operation, the drill bit 114 is rotated to grind and cut into the underlying rock formations and thereby progressively penetrate the earth 102 to create the wellbore 118. The BHA 104 provides directional control of the drill bit 114 as it advances into the earth 102 and extends the wellbore 118. Fluid or “mud” from a mud tank 120 may be pumped downhole using a mud pump 122 powered by an adjacent motor 124. The mud is pumped from the mud tank 120 through a stand pipe 126, which feeds the mud into the drill string 106 and conveys the same to the drill bit 114. The mud exits one or more nozzles provided in the drill bit 114 and helps cool the drill bit 114 as it operates. The mud then circulates back to the surface 110 via the annulus defined between the wellbore 118 and the drill string 106, and in the process returns drill cuttings and debris to the surface. The cuttings and mud mixture are passed through a flow line 128 and are processed such that a cleaned mud is returned down hole through the stand pipe 126 once again.

Although the system 100 is described herein with respect to drilling for hydrocarbons, the principles described herein may be equally applicable to other types of applications such as, but not limited to, drilling for mineral exploration, environmental investigation, natural gas extraction, underground installation, mining operations, water wells, geothermal wells, sub-surface boring applications and construction assemblies, disposal wells, and the like. Moreover, while the system 100 is depicted as a land-based operation, it will be appreciated that the principles of the present disclosure could equally be applied in any offshore, sea-based, or sub-sea application where the service rig may be a floating platform, a semi-submersible platform, or a sub-surface wellhead installation as generally known in the art.

The drill string 106 is made up of multiple pipes (alternately referred to herein as “tubular members” or “tubulars”) threadably connected together end-to-end. During oil and gas drilling operations, it is desirable that the threaded connections forming the drill string 106 have sufficient strength to withstand all expected service loads (e.g., torsion, tension, compression, etc.). Particularly, it is desirable that the threaded connections have sufficient torsional strength, which is a measure of the amount of torque applied about the centerline of the tubular connection required to cause failure. In order to optimize the torsional strength of the drill string 106 threaded connections, the threads must be designed to have a sufficient bearing and shear strength to avoid the common failures resulting from elevated torsion, as well as supporting tensile and compressive forces. Bearing strength is a measure of the amount of force required to cause deformation (e.g., plastic deformation) of engaged surfaces (e.g., thread flanks) of the threaded connection, and shear strength is a measure of the amount of force required to shear the threads between the thread flanks along a plane substantially parallel to the connection centerline.

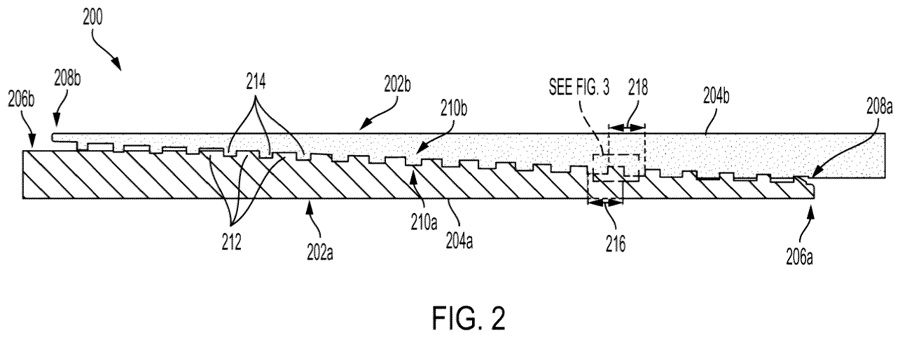

FIG. 2 is an enlarged, cross-sectional side view of an example threaded connection 200, according to at least one aspect of the present disclosure. As illustrated, the threaded connection 200 (also referred to as a “tool joint”) may include a pin 202a of a first tubular member 204a and a box 202b of a second tubular member 204b. The first and second tubular members 204a,b may comprise any type of tubing, pipe, or tubulars commonly used in the oil and gas industry and capable of being threadably connected end-to-end. Examples of the tubular members 204a,b include, but are not limited to, drill pipe, casing (or liner), production tubing, general tubular assemblies (e.g., a wellbore hanger, hydraulic fracturing tools, float equipment, etc.), or any combination thereof.

The pin 202a defines or otherwise provides a helically extending external thread profile 210a that includes a plurality of teeth 212. The teeth 212 are threadably engageable with a helically extending internal thread profile 210b that includes a plurality of teeth 214 defined or otherwise provided by the box 202b.

As used herein, the term “thread profile” refers to the thread form or configuration of a thread in an axial plane and which is generally considered to include a crest, a root, and opposing stab and load flanks. Moreover, as used herein, the term “stab flank” is intended to designate those flanks of the pin and box threads that first engage as the pin is stabbed into the box, and the term “load flank” is intended to designate those contacting flanks of the pin and box threads that normally contact with an increasing bearing pressure in reaction to the load forces tending to separate the engaged pin and box axially.

As illustrated, the width of the teeth 212 progressively changes; e.g., decreases from a first or “distal” end 206a of the thread profile 210a along the length of the threaded connection 200 and toward a second or “proximal” end 206b. For instance, a first tooth 212 positioned closer to the proximal end 206b of the thread profile 210a may exhibit a first width while a second tooth 212 positioned closed to the distal end 206a of the thread profile 210a may have a second width less than the first width. Conversely, the width of the teeth 214 progressively increases along the length of the thread profile 210b. For instance, a first tooth 214 positioned closer to a first or “distal” end 208a of the threaded connection 200 may have a first width while a second tooth 214 positioned closer to a second or “distal” end 208b of the thread profile 210b may have a second width greater than the first width.

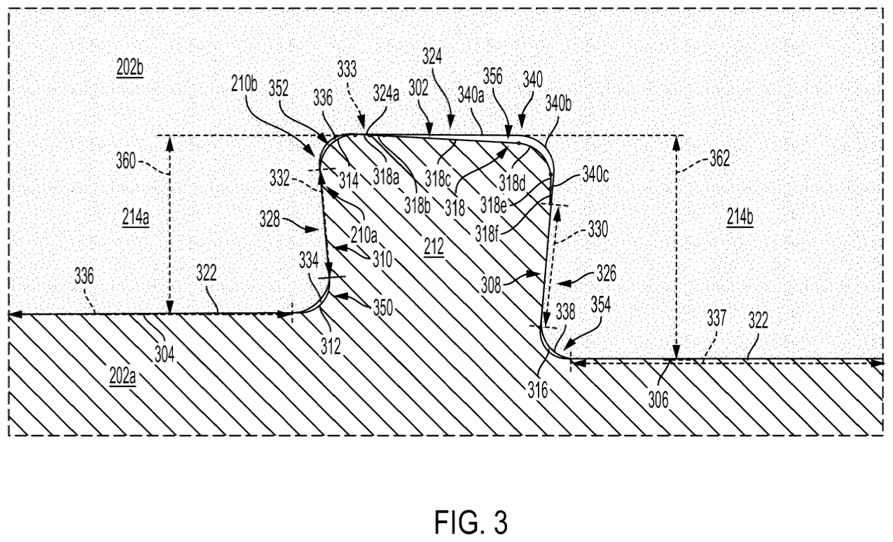

FIG. 3 is an enlarged view of a portion of the threaded engagement between the external and internal thread profiles 210a,b of FIG. 2, in accordance with at least one aspect of the present disclosure. As illustrated, the external thread profile 210a of the pin 202a is a modified dovetail wedge threadform where each tooth 212 (one shown) is defined by a crest 302, a load side root 304, a stab side root 306, a stab flank 308, and a load flank 310.

The tooth 212 interposes first and second teeth 214a and 214b of the external thread profile 210b of the box 202b. Each tooth 214a,b may be defined by a crest 322 that opposes a corresponding root 304, 306 of the tooth 212, a root 324 that opposes a corresponding crest 302 of the tooth 212, a stab flank 326 that opposes a corresponding stab flank 308 of the tooth 212, and a load flank 328 that opposes a corresponding load flank 310 of the tooth 212.

The width between successive stab flanks 308 of the teeth 212 along the first thread profile 210a may be different than the width between successive load flanks 310 of the teeth 214 along the second thread profile 210b. For instance, with reference to FIGS. 2 and 3, a width 216 between two successive stab flanks 308 of the teeth 212 may be different than a width between two successive load flanks 310 of the teeth 214. The width 216 may alternately be referred to as the stab flank lead “SFL”, and the width 218 may alternately be referred to as the load flank lead “LFL”. The changing width causes the threads to “lock” together, or one thread to wedge into the other, yield much higher torques than connections with shoulders (e.g. around 4 times the torque).

Referring again to FIG. 3, a first or “load flank” height 360 may be defined between the load side root 304 and the crest 302, and a second or “stab flank” height 362 may be defined between the stab side root 306 and the crest 302. The stab flank height 362 may different (greater or less) than the load flank height 360. For instance, the load flank height 360 may be about 0.0680 inches and the stab flank height 362 may be about 0.080 inches. Alternatively, the stab flank height 362 may equal to the load flank height 360.

The stab and load flank heights 360, 362 may be variable along the length of the threaded connection 200 (FIG. 2). For instance, the stab and load flank heights 360, 362 of a first tooth 212 positioned closer to the proximal end 206b (FIG. 2) may be different than (less than) the stab and load flank heights 360, 362 of a second tooth 212 positioned closer to the distal end 206a (FIG. 2). Alternatively, the stab and load flank heights 360, 362 may remain constant along the length of the threaded connection 200 (FIG. 2).

The opposing stab flanks 308, 326 may engage one another to define a stab flank contact height or “SFCH” 330 and the opposing load flanks 310, 328 may engage one another to define a load flank contact height or “LFCH” 332, which may be different (smaller or greater) than the SFCH 330. For example, the SFCH 330 may be 0.0465 inches and the LFCH 332 may be 0.0464 inches. However, other embodiments are envisioned in which the SFCH 330 and the LFCH 332 are identical.

The crest 302 may comprise a first linear portion 318a extending linearly from a second transition surface 314, discussed in more detail below, a first arcuate portion 318b extending radially from the first linear portion 318a, a second linear portion 318c extending linearly from the first arcuate portion 318b, a second arcuate portion 318d extending radially from the second linear portion 318c, a third linear portion 318e extending linearly from the second arcuate portion 318d, and a third arcuate portion 318f extending radially from the third linear portion 318e to the stab flank 308.

The first linear portion 318a of the crest 302 and a contact portion 324a of the root 324 may engage one another to define a first crest and root contact width “CRCW₁” 333. Similarly, the crest 322 and the corresponding roots (load or stab side roots 304, 306) may engage one another to define a second crest and root contact width “CRCW₂” 336 and a third crest and root contact width “CRCW₃” 337, respectively. The second and third widths CRCW₂, CRCW₃ 336, 337 may each be greater than the first width CRCW₁ 333. In some embodiments, the second CRCW₂ 336 and third CRCW₃ 337 may be the same magnitude (e.g., CRCW₂=CRCW₃), or they may be different (e.g., CRCW₂>CRCW₃ or CRCW₂<CRCW₃).

The threaded engagement between the external and internal thread profiles 210a,b may define a plurality of thread gaps. As illustrated in FIG. 3, the tooth 212 may include a first transition surface 312 that extends radially from the load side root 304 to the load flank 310, and the tooth 214a may include a first transition surface 334 that extends radially from the crest 332 to the load flank 328. The first transition surface 312 exhibits a radius (or “radius of curvature”) and the first transition surface 334 also exhibit a radius, but is greater than the radius of the transition surface 312 such that a first thread gap 350 is defined therebetween. The radius of the first transition surface 312 may be about 0.008 inches, for example. However, other embodiments are envisioned where the radius of the first transition surface 312 is less than or greater than 0.008 inches.

As referenced above, the tooth 212 may further include a second transition surface 314 that extends radially from the load flank 310 to the first linear portion 318a of the crest 302, and the tooth 214a may include a second transition surface 336 that extends radially from the load flank 328 to the root contact portion 324a. The second transition surface 314 exhibits a radius (or “radius of curvature”) and the transition surface 336 also exhibits a radius, but is less than the radius of the transition surface 314 such that a second thread gap 352 is defined therebetween. The radius of the transition surface 314 may be 0.010 inches, for example. However, other embodiments are envisioned where the radius of the transition surface 314 is less than or greater than 0.010 inches.

The tooth 212 may further include a third transition surface 316 that extends radially from the stab flank 308 to the stab side root 306, and the tooth 214b may include a third transition surface 338 that extends radially from the stab flank 326 to the crest 322. The transition surface 316 exhibits a radius (or “radius of curvature”) and the transition surface 338 also exhibits a radius, but is greater than the radius of the transition surface 316 such that a third gap 354 is defined therebetween. The radius of the transition surface 316 may be the same, or substantially the same, as the radius of the transition surface 312. For instance, the radius of the transition surface 316 may be 0.008 inches, for example. However, other embodiments are envisioned where the radius of the transition surface 316 is less than or greater than 0.008 inches.

The tooth 212 may further include a fourth transition surface 318, alternatively referred to as a “constrictor notch”, that extends radially and linearly relative to the second transition surface 314 to the stab flank 308. In some embodiments, the fourth transition surface 318 forms part of, and otherwise helps define, the shape and geometry of the crest 302. More specifically, the constrictor notch 318 may include the first, second, and third linear portions 318a, 318c, 318e and the first, second, and third arcuate portions 318b, 318d, 318f.

The teeth 214a,b may include, or otherwise define, a fourth transition surface 340 that extends linearly and radially from the root contact portion 324a of the root 324 to the stab flank 326. The fourth transition surface 340 may include a first linear portion 340a extending linearly from the root contact portion 324a, an arcuate portion 340b extending radially from the first linear portion 340a, and a second linear portion 340c extending linearly from the arcuate portion 340b to the stab flank 326. The first linear portion 340a may generally oppose the first arcuate portion 318b and second linear portion 318c along their lengths thereof, the arcuate portion 340b may generally oppose the second arcuate portion 318d along the arcuate length thereof, and the second linear portion 340c may generally oppose the third linear portion 318e and the third arcuate portion 318f along their lengths thereof.

The root contact portion 324a and the first linear portion 340a may collectively define the root 324, and the first linear portion 340a may linearly extend from the root contact portion 324a in an un-angled fashioned. Stated another way, the first linear portion 340a may linearly extend from the root contact portion 324a such that the root 324 defines a straight or “horizontal” line. In contrast, since it extends from the arcuate section 318b that extends radially from the linear section 318a spanning the CRCW₁ 333, the second linear portion 318c of the constrictor notch 318 may be angled relative to the first linear portion 340a, such as at about a 3⁰ angle.

As illustrated, the first linear portion 318a may account for a minority of the width of the tooth 212 and the second linear portion 318c may account for a majority of the width of the tooth 212. For instance, first linear portion 318a may extend about a first width of the tooth 212 (e.g. about 10%) and the second linear portion 318c may extend a second width of the tooth 212 greater than the first width (e.g. about 75%). Other embodiments are envisioned where the first linear portion 318a may extend less than 10% of the width of the tooth 212 (e.g., 2.5%, 5%, or 7.5%) or greater than 10% of the width of the tooth 212 (e.g., 25%, 35%, 50%). Other embodiments are envisioned where the second linear portion 318c may extend less than 75% of the width of the tooth 212 (e.g., 25%, 35%, 50%, 60%) or greater than 75% of the width of the tooth 212 (e.g., 80%, 85%, 90%).

The percentage of the width of the teeth 212 made up by the first linear portion 318a may change along the length of the threaded connection 200. For instance, a first tooth 212 positioned at, or near, the proximal end 206b (FIG. 2) may have a first linear portion 318a that accounts for a first percentage of the width of the respective tooth 212 (e.g. about 10%) while a second tooth 212 positioned at, or near, the distal end 206a (FIG. 2) may have a first linear portion 318a that accounts for a second percentage of the width of the respective tooth 212 greater than the first percentage (e.g. about 75%).

The length of the first and second linear portions 318a,c may be variable between teeth 212. For instance, as referenced above, the width of the teeth 212 may progressively decrease along the length of the threaded connection 200 from the proximal end 206b (FIG. 2) to the distal end 206a (FIG. 2), as shown in FIG. 2. In some such embodiments, a first tooth 212 positioned closer to the proximal end 206b (FIG. 2) of the thread profile 210a (FIG. 2) may have a first width while a second tooth 212 positioned closer to the distal end 206b (FIG. 2) of the thread profile 210a may have a second width less than the first width. Accordingly, the length of the first linear portion 318a,c of each tooth 212 may progressively decrease along the length of the thread profile 210a from the proximal end 206a to the distal end 206b.

Alternatively, the length of the first and second linear portions 318a,c may be identical between teeth 212. For instance, as referenced above, the width of the teeth 212 may progressively decrease along the length of the threaded connection 200 from the proximal end 206b (FIG. 2) to the distal end 206a (FIG. 2), as shown in FIG. 2. In some such embodiments, the second linear portion 318c of a first tooth 212 positioned closer to the proximal end 206b may account for a first percentage of the width of the tooth 212 (e.g. about 25%), while the second linear portion 318c of a second tooth 212 positioned closer to the distal end 206a (FIG. 2) may account for a second percentage of the width of the tooth 212 greater than the first percentage (e.g. about 75%).

The angle of the linear portion 318b may remain fixed. For instance, a first tooth 212 positioned closer to the proximal end 206a may include a second linear portion 318c that is angled at a first angle relative to an adjacent root contact portion 324a and may have a first length, while a second tooth 212 positioned closed to the distal end 206b may include a second linear portion 318c that is angled relative to an adjacent root contact portion 324a at a second angle identical to the first angle, but may have a second length that is different than (less than) the first length. Accordingly, the second linear portions 318c of the teeth 212 may all be angled such that they are parallel to one another along the length of the threaded connection 200, but exhibit different lengths.

The constrictor notch 318 and the transition surface 340 may cooperatively define a fourth gap 356 therebetween, alternatively referred to as a “constrictor notch gap”, which may be larger (i.e., in volume) than the first, second, and third gaps 350, 352, 354. The constrictor notch gap 356 is designed reduce dope entrapment within the threaded connection 200 without sacrificing pressure performance thereof. For instance, the constrictor notch gap 356 may hold and pressurize thread compound within the threaded connection 200 (FIG. 2) as opposed to simply relieving the pressure. Furthermore, the third linear portion 318e, alternatively referred to as a “make-up flat”, may offer improved resistance during stabbing as compared to typical dove-tail wedge thread forms.

The shape of the constrictor notch gap 356 may be defined by a set of geometric constraints. For instance, the constrictor notch gap 356 may require a hydraulic diameter D_{H} of less than about 0.004 inches (0.102 mm), with the hydraulic diameter D_{H} being defined as:

$${D}_{H} = \frac{4 \times A}{P}$$

where “A” is the area of the constrictor notch gap 356, and “P” is the perimeter of the constrictor notch gap 356. For reference, the API buttress thread form stab flank D_{H} is 0.0056 inches (0.142 mm). To satisfy the hydraulic diameter D_{H} of less than 0.004 inches (0.102 mm), the area “A” of the constrictor notch gap 356 may be about 0.000173 in² (0.112 mm²) and the perimeter “P” of the gap 356 may be about 0.1967 inches (4.996 mm). For reference, the API buttress radius gaps are less than 0.000031 inches² (0.02 mm²).

In the alternative, or in addition thereto, the size of the third gap 354 may be adjusted such that the third gap 354 satisfies the aforementioned geometric constraints to be considered a constrictor notch gap. The third gap 354 may be adjusted by adjusting one or more of the transition surfaces 316, 338 and the stab flanks 308, 326 to satisfy the aforementioned geometric constraints. In such embodiments, the teeth 212, 214b may define a constrictor notch gap at the third gap 354 in lieu of at the fourth gap 356, or may define a second constrictor notch gap at the third gap 354 in combination with the constrictor notch gap at the fourth gap 356.

Embodiments disclosed herein include:

A. A system comprising a first tubular member having a pin end defining an external thread profile, the external thread profile providing a tooth that includes a first transition surface extending from a load side root, a load flank extending from the first transition surface, a second transition surface extending from the load flank, a third transition surface extending from the second transition surface, a stab flank extending from the third transition surface, and a fourth transition surface extending from the stab flank and transitioning to a stab side root, wherein the third transition surface comprises, a first linear portion extending from the second transition surface, a first arcuate portion extending from the first linear portion, a second linear portion extending from the first arcuate portion, a second arcuate portion extending from the second linear portion, a third linear portion extending from the second arcuate portion, and a third arcuate portion extending from the third linear portion to the stab flank.

B. A system comprising a first tubular defining an external thread profile, the external thread profile providing a tooth that includes, a load flank, a first transition surface extending from the load flank, a second transition surface extending from the first transition surface, and a stab flank extending from the second transition surface, wherein the second transition surface comprises, a first linear portion extending from the first transition surface, a first arcuate portion extending from the first linear portion, a second linear portion extending from the first arcuate portion, a second arcuate portion extending from the second linear portion, a third linear portion extending from the second arcuate portion, and a third arcuate portion extending from the third linear portion to the stab flank.

Each of embodiments A and B may have one or more of the following additional elements in any combination: Element 1: further comprising a second tubular member having a box end defining an internal thread profile threadably engageable with the external thread profile, the internal thread profile providing a first crest in contact with the load side root, a first transition surface extending from the first crest and opposing the first transition surface of the tooth, a load flank extending from the first transition surface and contactable with the load flank of the tooth, a second transition surface extending from the load flank and opposing the second transition surface of the tooth, a root contact portion extending from the second transition surface and engaging the first linear portion of the tooth, a third transition surface extending from the root contact portion and opposing the second and third linear portions and the first, second, and third arcuate portions of the tooth to define a gap therebetween, a stab flank extending from the third transition surface and contactable with the stab flank of the tooth, a fourth transition surface extending from the stab flank and opposing the fourth transition surface of the tooth, and a second crest extending from the fourth transition surface and in contract with the stab side root. Element 2: wherein the third transition surface of the internal thread profile comprises a first linear portion extending from the root contact portion, an arcuate portion extending from the first linear portion, and a second linear portion extending from the arcuate portion to the stab flank of the internal thread profile. Element 3: wherein the first linear portion of the internal thread profile opposes the first arcuate portion and second linear portion of the tooth, the arcuate portion of the internal thread profile opposes the second arcuate portion of the tooth, and the second linear portion of the internal thread profile opposes the third linear portion and the third arcuate portion of the tooth. Element 4: wherein the second linear portion of the tooth is angled relative to the first linear portion of the internal thread profile. Element 5: wherein the angle is about 3 degrees. Element 6: wherein the gap is defined by a hydraulic diameter of less than 0.0040 inches. Element 7: wherein the load flanks of the external and internal thread profiles are contactable along a load flank contact height, and the stab flanks of the external and internal threads are contactable along a stab flank contact height that is different than the load flank contact height. Element 8: wherein the gap is a first gap, and wherein a second gap is defined between the first transition surfaces of the tooth and the internal thread profile. Element 9: wherein the gap is a first gap, and wherein a second gap is defined between the second transition surfaces of the tooth and the internal thread profile. Element 10: wherein the gap is a first gap, and wherein a second gap is defined between the fourth transition surfaces of the tooth and the internal thread profile. Element 11: wherein the gap is a first gap, and wherein a second gap is defined between the first transition surface of the tooth and the internal thread profile, a third gap is defined between the second transition surfaces of the tooth and the internal thread profile, and a fourth gap is defined between the fourth transition surfaces of the tooth and the internal thread profile. Element 12: further comprising a second tubular defining an internal thread profile threadably engageable with the external thread profile, the internal thread profile providing, a load flank contactable with the load flank of the tooth, a first transition surface extending from the load flank and opposing the first transition surface of the tooth, a root contact portion extending from the first transition surface and engaging the first linear portion of the tooth, a second transition surface extending from the root contact portion and opposing the second and third linear portions and the first, second, and third arcuate portions of the tooth and thereby defining a gap therebetween, and a stab flank extending from the second transition surface of the internal thread profile and contactable with the stab flank of the tooth. Element 13: wherein the second transition surface of the internal thread profile comprises a first linear portion extending from the root contact portion, an arcuate portion extending from the first linear portion, and a second linear portion extending from the arcuate portion to the stab flank of the internal thread profile. Element 14: wherein the first linear portion of the internal thread profile opposes the first arcuate portion and second linear portion of the tooth, the arcuate portion of the internal thread profile opposes the second arcuate portion of the tooth, and the second linear portion of the internal thread profile opposes the third linear portion and the third arcuate portion of the tooth. Element 15: wherein the second linear portion of the tooth is angled relative to the first linear portion of the internal thread profile. Element 16: wherein the angle is about 3 degrees. Element 17: wherein the gap is defined by a hydraulic diameter of less than 0.0040 inches. Element 18: wherein the gap is a first gap, and wherein a second gap is defined between the first transition surfaces of the external and internal threads.

By way of non-limiting example, exemplary combinations applicable to A and B include: Element 1 with Element 2; Element 1 with Elements 2 and 3; Element 1 with Elements 2 and 4; Element 1 with Elements 2, 4, and 5, Element 1 with Element 6; Element 1 with Element 7; Element 1 with Element 8; Element 1 with Element 9; Element 1 with Element 10; Element 1 with Element 11; Element 12 with Element 13; Element 12 with Elements 13 and 14; Element 12 with Elements 13 and 15; Element 12 with Elements 13, 15, and 16; Element 12 with Element 17.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A system, comprising:
a first tubular member having a pin end defining an external thread profile, the external thread profile providing a tooth that includes:
a first transition surface extending from a load side root;
a load flank extending from the first transition surface;
a second transition surface extending from the load flank;
a third transition surface extending from the second transition surface;
a stab flank extending from the third transition surface; and
a fourth transition surface extending from the stab flank and transitioning to a stab side root;
wherein the third transition surface comprises:
a first linear portion extending from the second transition surface;
a first arcuate portion extending from the first linear portion;
a second linear portion extending from the first arcuate portion;
a second arcuate portion extending from the second linear portion;
a third linear portion extending from the second arcuate portion; and
a third arcuate portion extending from the third linear portion to the stab flank.

2. The system of claim 1, further comprising a second tubular member having a box end defining an internal thread profile threadably engageable with the external thread profile, the internal thread profile providing:
a first crest in contact with the load side root;
a first transition surface extending from the first crest and opposing the first transition surface of the tooth;
a load flank extending from the first transition surface and contactable with the load flank of the tooth;
a second transition surface extending from the load flank and opposing the second transition surface of the tooth;
a root contact portion extending from the second transition surface and engaging the first linear portion of the tooth;
a third transition surface extending from the root contact portion and opposing the second and third linear portions and the first, second, and third arcuate portions of the tooth to define a gap therebetween;
a stab flank extending from the third transition surface and contactable with the stab flank of the tooth;
a fourth transition surface extending from the stab flank and opposing the fourth transition surface of the tooth; and
a second crest extending from the fourth transition surface and in contract with the stab side root.

3. The system of claim 2, wherein the third transition surface of the internal thread profile comprises:
a first linear portion extending from the root contact portion;
an arcuate portion extending from the first linear portion; and
a second linear portion extending from the arcuate portion to the stab flank of the internal thread profile.

4. The system of claim 3, wherein:
the first linear portion of the internal thread profile opposes the first arcuate portion and second linear portion of the tooth;
the arcuate portion of the internal thread profile opposes the second arcuate portion of the tooth; and
the second linear portion of the internal thread profile opposes the third linear portion and the third arcuate portion of the tooth.

5. The system of claim 3, wherein the second linear portion of the tooth is angled relative to the first linear portion of the internal thread profile.

6. The system of claim 5, wherein the angle is about 3 degrees.

7. The system of claim 2, wherein the gap is defined by a hydraulic diameter of less than 0.0040 inches.

8. The system of claim 2, wherein the load flanks of the external and internal thread profiles are contactable along a load flank contact height, and the stab flanks of the external and internal threads are contactable along a stab flank contact height that is different than the load flank contact height.

9. The system of claim 2, wherein the gap is a first gap, and wherein a second gap is defined between the first transition surfaces of the tooth and the internal thread profile.

10. The system of claim 2, wherein the gap is a first gap, and wherein a second gap is defined between the second transition surfaces of the tooth and the internal thread profile.

11. The system of claim 2, wherein the gap is a first gap, and wherein a second gap is defined between the fourth transition surfaces of the tooth and the internal thread profile.

12. The system of claim 2, wherein the gap is a first gap, and wherein:
a second gap is defined between the first transition surface of the tooth and the internal thread profile;
a third gap is defined between the second transition surfaces of the tooth and the internal thread profile; and
a fourth gap is defined between the fourth transition surfaces of the tooth and the internal thread profile.

13. A system, comprising:
a first tubular defining an external thread profile, the external thread profile providing a tooth that includes:
a load flank;
a first transition surface extending from the load flank;
a second transition surface extending from the first transition surface; and
a stab flank extending from the second transition surface;
wherein the second transition surface comprises:
a first linear portion extending from the first transition surface;
a first arcuate portion extending from the first linear portion;
a second linear portion extending from the first arcuate portion;
a second arcuate portion extending from the second linear portion;
a third linear portion extending from the second arcuate portion; and
a third arcuate portion extending from the third linear portion to the stab flank.

14. The system of claim 13, further comprising a second tubular defining an internal thread profile threadably engageable with the external thread profile, the internal thread profile providing:
a load flank contactable with the load flank of the tooth;
a first transition surface extending from the load flank and opposing the first transition surface of the tooth;
a root contact portion extending from the first transition surface and engaging the first linear portion of the tooth;
a second transition surface extending from the root contact portion and opposing the second and third linear portions and the first, second, and third arcuate portions of the tooth and thereby defining a gap therebetween; and
a stab flank extending from the second transition surface of the internal thread profile and contactable with the stab flank of the tooth.

15. The system of claim 14, wherein the second transition surface of the internal thread profile comprises:
a first linear portion extending from the root contact portion;
an arcuate portion extending from the first linear portion; and
a second linear portion extending from the arcuate portion to the stab flank of the internal thread profile.

16. The system of claim 15, wherein:
the first linear portion of the internal thread profile opposes the first arcuate portion and second linear portion of the tooth;
the arcuate portion of the internal thread profile opposes the second arcuate portion of the tooth; and
the second linear portion of the internal thread profile opposes the third linear portion and the third arcuate portion of the tooth.

17. The system of claim 15, wherein the second linear portion of the tooth is angled relative to the first linear portion of the internal thread profile.

18. The system of claim 17, wherein the angle is about 3 degrees.

19. The system of claim 14, wherein the gap is defined by a hydraulic diameter of less than 0.0040 inches.

20. The system of claim 13, wherein the gap is a first gap, and wherein a second gap is defined between the first transition surfaces of the external and internal threads.
